(19) United States
(12) Patent Application Publication
(10) Pub. No.: US 2014/0223152 A1
(43) Pub. Date: Aug. 7, 2014

(54) CONFIGURING OPERATING SYSTEM ADMINISTRATION CAPABILITIES USING AN EMBEDDED WORKFLOW ENGINE

(71) Applicant: INTERNATIONAL BUSINESS MACHINES CORPORATION, Armonk, NY (US)

(72) Inventors: Anuja Deedwaniya, Poughkeepsie, NY (US); Gary S. Puchkoff, Poughkeepsie, NY (US)

(73) Assignee: INTERNATIONAL BUSINESS MACHINES CORPORATION, Armonk, NY (US)

(21) Appl. No.: 13/756,768

(22) Filed: Feb. 1, 2013

(51) Int. Cl. G06F 9/445

(52) U.S. Cl. CPC G06F 9/44505
USPC 713/1

(57) ABSTRACT

Embodiments include methods, systems and computer program products for executing a workflow having a plurality of steps to configure an operating system. The method includes assigning, with a workflow engine operated by a processing device, an owner to each of the plurality of steps and receiving a notification of acceptance from the owner assigned to each of the plurality of steps. The method also includes monitoring a state of each of the plurality of steps, notifying the owner of each of the plurality of steps when a step owned by the owner is ready for execution and indicating that the workflow is complete when all of the plurality of steps has reached a terminal state.

### BACKGROUND

Exemplary embodiments relate to the configuration of an operating system, and more specifically, to methods and systems for configuring operating system administration capabilities using an embedded workflow engine.

During the installation or configuration of an operating system, or functional subsets of an operating system, a number of complex interdependent configuration actions are often required. These configuration actions may be required to install the operating system, to install middleware or applications, to migrate the operating system, to migrate the middleware, to remove middleware or applications, and to configure optional features. In many cases, these configuration actions each may have a separate set of instructions, interfaces or tools which makes configuring the operating system a very complex task. Currently, one or more sets of instructions and requirements documents are provided for each of the configuration actions. As the operating systems evolve and become more mature, the documentation gets increasingly complex and configuration of the products can require hours of planning In addition, even with proper planning errors or missed steps often occur during the configuration process.

Currently, some applications include specialized tools for installing the applications. However, each of these tools often requires the user to learn a new interface and installation procedure. In many cases, the process of configuring lower level operating system artifacts is not preformed by the installation tool and is left to be manually performed by the user. In addition, the installation tools typically do not facilitate configuration beyond defaults that are required for the application to work in the user's environment.

In general, large systems have a naming convention that is unique to their environment and configuration of the operating system is required. Currently available tools are typically external and have to be installed on the system to then configure the product on the system. In addition, these tools do not provide a consistent interface for administration and configuring of operating system functions from within the operating system.

### SUMMARY

According to an exemplary embodiment, a method is provided for executing a workflow having a plurality of steps to configure an operating system. The method includes assigning, with a workflow engine operated by a processing device, an owner to each of the plurality of steps and receiving a notification of acceptance from the owner assigned to each of the plurality of steps. The method also includes monitoring a state of each of the plurality of steps, notifying the owner of each of the plurality of steps when a step owned by the owner is ready for execution and indicating that the workflow is complete when all of the plurality of steps have reached a terminal state.

According to another exemplary embodiment, a computer system configured for executing a workflow having a plurality of steps to configure an operating system. The computer system includes a processor and a workflow engine configured to operate on the processor, the workflow engine being configured to assign an owner to each of the plurality of steps and receive a notification of acceptance from the owner assigned to each of the plurality of steps. The workflow engine being further configured to monitor a state of each of the plurality of steps, notify the owner of each of the plurality of steps when a step owned by the owner is ready for execution and indicate that the workflow is complete when all of the plurality of steps has reached a terminal state.

According to a further exemplary embodiment, a computer program product for executing a workflow having a plurality of steps to configure an operating system is provided. The computer program product comprises a computer readable storage medium having computer readable program code embodied therewith. The computer readable program code being configured for assigning, with a workflow engine operated by a processing device, an owner to each of the plurality of steps and receiving a notification of acceptance from the owner assigned to each of the plurality of steps. The computer readable program code being further configured for monitoring a state of each of the plurality of steps, notifying the owner of each of the plurality of steps when a step owned by the owner is ready for execution and indicating that the workflow is complete when all of the plurality of steps have reached a terminal state.

Additional features are realized through the techniques of the present disclosure. Other systems, methods, apparatus, and/or computer program products according to other embodiments are described in detail herein and are considered a part of the claimed invention. For a better understanding of exemplary embodiments and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features of the present disclosure are apparent from the following detailed description taken in conjunction with the accompanying drawings in which:

FIG. 1 is a block diagram of a computer system according to an exemplary embodiment.

FIG. 2A is an illustration of user interface for executing a workflow for configuration of an operating system in accordance with an exemplary embodiment.

FIG. 2B is an illustration of user interface for executing a workflow for configuration of an operating system in accordance with an exemplary embodiment.

FIG. 3 is a state diagram illustrating the execution of a workflow for configuration of an operating system in accordance with an exemplary embodiment.

FIG. 4 is an illustration of a history file for the execution of a workflow for configuration of an operating system in accordance with an exemplary embodiment.

### DETAILED DESCRIPTION

Exemplary embodiments of this disclosure include a workflow engine for configuration of an operating system and its component parts that is provided as part of the operating system. In exemplary embodiments, the workflow engine can be used to define the configuration steps required. In exemplary embodiments, the workflow includes various steps that can be automated, semi-automated, or manual. The workflow engine ensures that dependent steps are executed in the proper order and can be used to associate various steps with a role to ensure that a person with the proper skills or permissions performs the configuration task.

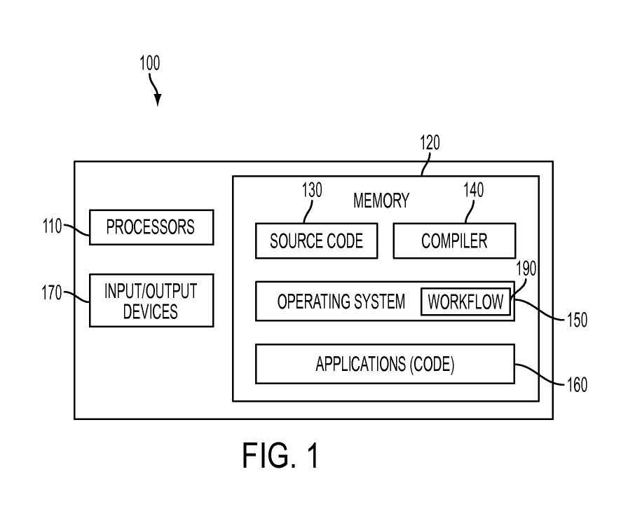

Referring now to FIG. 1, an example of a computer system 100 that can be included in exemplary embodiments is shown. Various methods, procedures, modules, flow diagrams, tools, application, and techniques discussed herein may also incorporate and/or utilize the capabilities of the computer system 100. Moreover, capabilities of the computer system 100 may be utilized to implement features of exemplary embodiments discussed herein.

Generally, in terms of hardware architecture, the computer system 100 may include one or more processors 110, computer readable storage memory 120, and one or more input and/or output (I/O) devices 170 that are communicatively coupled via a local interface (not shown). The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 110 is a hardware device for executing software that can be stored in the memory 120. The processor 110 can be virtually any custom made or commercially available processor, a central processing unit (CPU), a data signal processor (DSP), or an auxiliary processor among several processors associated with the computer system 100, and the processor 110 may be a semiconductor based microprocessor (in the form of a microchip) or a macroprocessor.

The computer readable memory 120 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 120 may incorporate electronic, magnetic, optical, and/or other types of storage media. Note that the memory 120 can have a distributed architecture, where various components are situated remote from one another, but can be accessed by the processor 110.

The software in the computer readable memory 120 may include one or more separate programs, each of which comprises an ordered listing of executable instructions for implementing logical functions. The software in the memory 120 includes a suitable operating system (O/S) 150, compiler 140, source code 130, and one or more applications 160 of the exemplary embodiments. As illustrated, the application 160 comprises numerous functional components for implementing the features, processes, methods, functions, and operations of the exemplary embodiments. The application 160 of the computer system 100 may represent numerous applications, agents, software components, modules, interfaces, controllers, etc., as discussed herein but the application 160 is not meant to be a limitation.

The operating system 150 may control the execution of other computer programs, and provides scheduling, input-output control, file and data management, memory management, and communication control and related services. In exemplary embodiments, the operating system 150 may include a workflow engine 190. The workflow engine 190 is used for configuration of the operating system 150 and its component parts

The application(s) 160 may employ a service-oriented architecture, which may be a collection of services that communicate with each. Also, the service-oriented architecture allows two or more services to coordinate and/or perform activities (e.g., on behalf of one another). Each interaction between services can be self-contained and loosely coupled, so that each interaction is independent of any other interaction.

Further, the application 160 may be a source program, executable program (object code), script, or any other entity comprising a set of instructions to be performed. When a source program, then the program is usually translated via a compiler (such as the compiler 140), assembler, interpreter, or the like, which may or may not be included within the memory 120, so as to operate properly in connection with the O/S 150. Furthermore, the application 160 can be written as (a) an object oriented programming language, which has classes of data and methods, or (b) a procedure programming language, which has routines, subroutines, and/or functions.

The I/O devices 170 may include input devices (or peripherals) such as, for example but not limited to, a mouse, keyboard, scanner, microphone, camera, etc. Furthermore, the I/O devices 170 may also include output devices (or peripherals), for example but not limited to, a printer, display, etc. Finally, the I/O devices 170 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 170 also include components for communicating over various networks, such as the Internet or an intranet. The I/O devices 170 may be connected to and/or communicate with the processor 110 utilizing Bluetooth connections and cables (via, e.g., Universal Serial Bus (USB) ports, serial ports, parallel ports, FireWire, HDMI (High-Definition Multimedia Interface), etc.).

When the computer system 100 is in operation, the processor 110 is configured to execute software stored within the memory 120, to communicate data to and from the memory 120, and to generally control operations of the computer system 100 pursuant to the software. The application 160 and the O/S 150 are read, in whole or in part, by the processor 110, perhaps buffered within the processor 110, and then executed.

When the application 160 is implemented in software it should be noted that the application 160 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 160 can be embodied in any computer-readable medium 120 for use by or in connection with an instruction execution system, apparatus, server, or device, such as a computer-based system, processor-containing system, or other system that can fetch the instructions from the instruction execution system, apparatus, or device and execute the instructions. In the context of this document, a “computer-readable storage medium” can be any means that can store, read, write, communicate, or transport the program for use by or in connection with the instruction execution system, apparatus, or device. The computer readable medium can be, for example but not limited to, an electronic, magnetic, optical, or semiconductor system, apparatus, or device.

More specific examples (a nonexhaustive list) of the computer-readable medium 120 would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W, DVD, Blue-ray™, tape, etc.) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 160 is implemented in hardware, the application 160 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer system 100 includes non-limiting examples of software and hardware components that may be included in various devices, servers, and systems discussed herein, and it is understood that additional software and hardware components may be included in the various devices and systems discussed in exemplary embodiments.

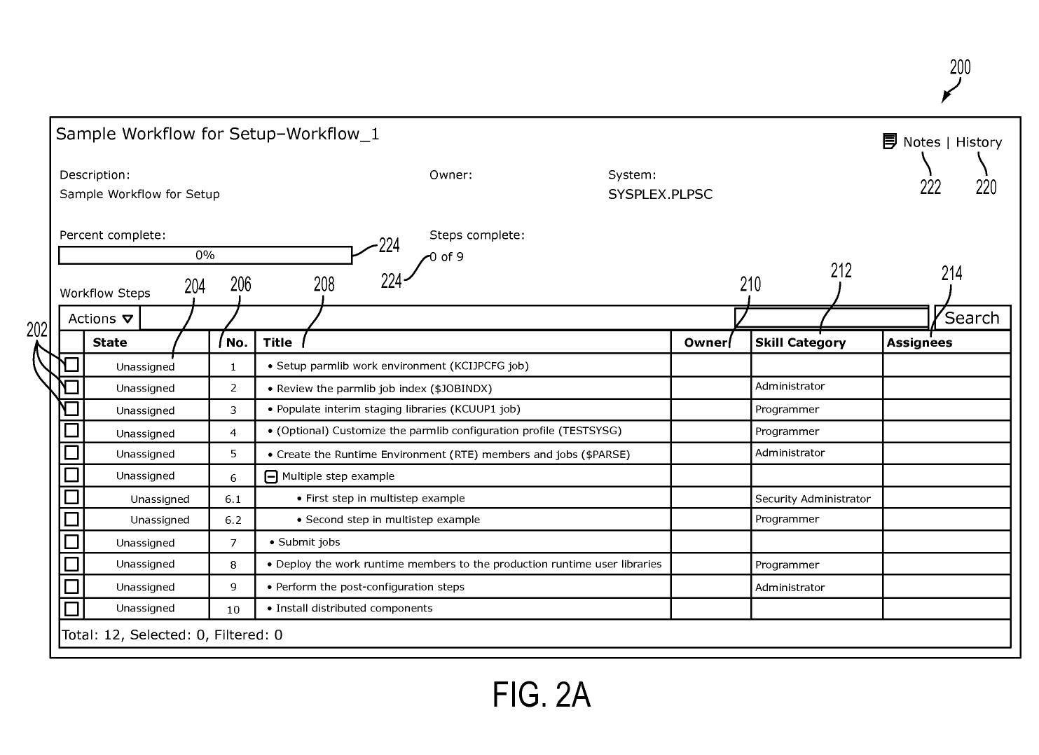

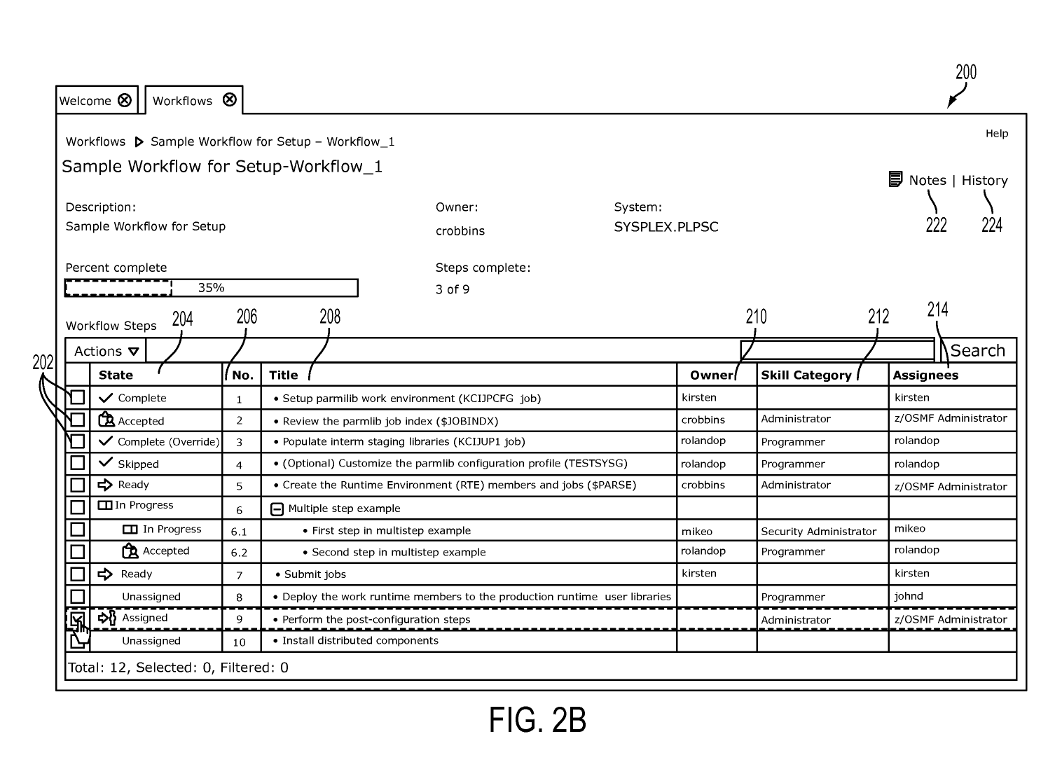

Referring now to FIGS. 2A and 2B, user interface 200 for executing a workflow in accordance with an exemplary embodiment are shown. As illustrated, the user interface 200 is configured to facilitate the execution of a workflow for the configuring an operating system. In exemplary embodiments, the workflow includes several steps 202 which each correspond to a separate configuration activity. In exemplary embodiments, these configuration activities may be automated, semi-automated or manual, and the workflow is designed to provide end-to-end guidance at different levels of granularity. In addition, the workflow ensures that dependent steps are executed in the proper order. In exemplary embodiments, the workflow may be used to track progress and completion of configuration tasks at a configurable level of granularity.

In exemplary embodiments, the workflow may include a plurality of steps 202. Each of the steps 202 may include a state 204, a number 206, a title 208, an owner 210, a skill category 212, and an assignee 214. In exemplary embodiments, the steps 202 of the workflow can be assigned to users that have a specific role or belong to a skill category 212, also referred to as a permission level. For example, the skill category 212 of each workflow step 202 may include, but is not limited to, system administrator, security administrator, storage administrator, networking administrator, etc. In exemplary embodiments, the owner of a workflow can create custom roles or skill categories 212 that can be used in assigning the steps 202 of the workflow. Accordingly, the workflow can be used to ensure that an individual with the proper skills and/or permissions is assigned to perform each configuration activity. In exemplary embodiments, the skill category may be provided by the workflow author and is the suggested skills that a person should have for performing for the step. While the workflow owner may or may not follow the skills category recommendation in assigning the steps of the workflow, the owner and assigned person must be a defined, authorized user on the system. The assignee can be at the discretion of the workflow owner and must be a valid/authorized user on the system and may belong to a role that is defined on the system and understood by the workflow application. In addition, each step 202 may include an owner 210 that is assigned and accepts the responsibility of performing the step 202. In exemplary embodiments, the assignee 214 may be the same as the owner 210 or may be a person delegated to perform the step 202 by the owner 210. In one embodiment, the assignee 214 may be a specific user. In another embodiment, the assignee 214 may include a group of specific users or users within a group. In exemplary embodiments, the state 204 of each workflow step 202 may include, but is not limited to, unassigned, assigned, accepted, skipped, in progress, complete, ready, etc.

In exemplary embodiments, an operating system may include a database of configuration templates and each template may include a configuration document and other related documents. The database of templates may include templates relating to various products and it may also include templates that relate to basic functions of the operating system. The database of templates may also have templates that are created by, or for, a vendor product or a customer. The templates are internally divided into lower level parts called steps, which can be categorized as sequential or parallel, nested, dependent on independent, and required or optional.

In exemplary embodiments, a user can create new templates or can modify an existing template by the use of an editor, such as a text editor or a graphical user interface. In many cases, customers of an operating system will typically tailor an existing template that was provided with the operating system. As described above with reference to FIGS. 2A and 2B, the operating system includes a graphical interface that allows a user to select a template, either one shipped by a vendor or one that has been tailored, and begin preforming the workflow process. At this point the template gets read in and stored in a work in process file. In exemplary embodiments, the user interface can be used to see the list of work in process files, which are also referred to as active workflows.

In exemplary embodiments, the user interface 200 may include one or more status indicators 224 that track and display the status of the execution of the workflow. In addition, the user interface 200 may include a history icon 220 and a notes 222 icon which can be used to selectively display a history file and a notes file associated with the execution of the workflow. In exemplary embodiments, the history file is used to log the actions performed with respect to the workflow including, but not limited to, the users who were assigned to and completed of each step 202 of the work flow. In exemplary embodiments, the notes file is configured to keep any notes relating to the execution of the workflow such as notes from the owners 210 of the steps 202 regarding their performance of the steps 202.

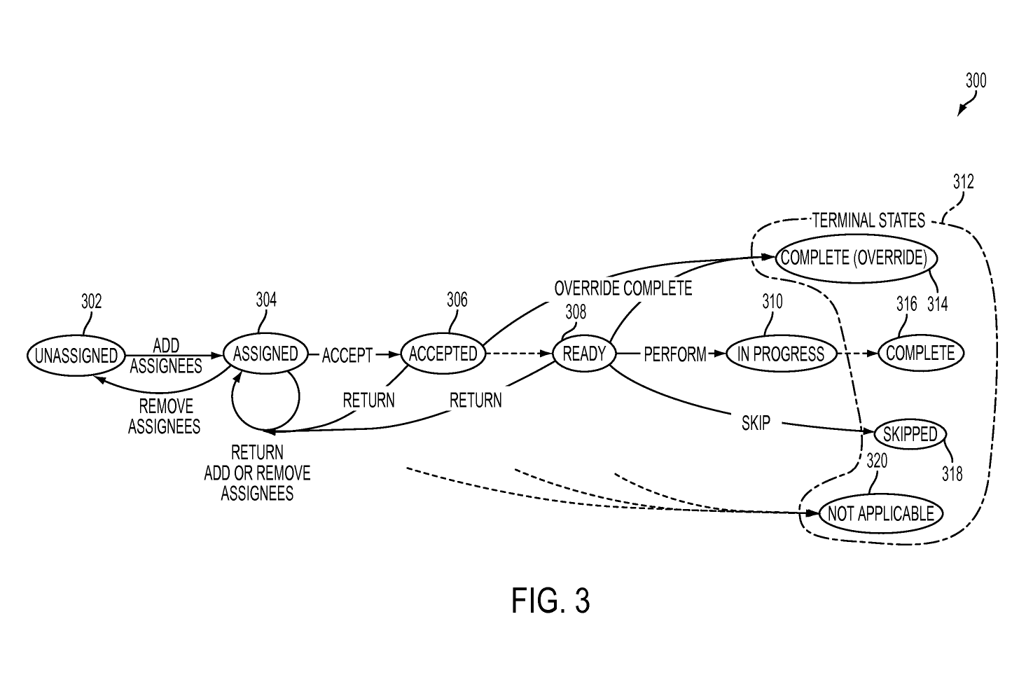

Referring now to FIG. 3, a state diagram 300 illustrating the possible changes of a state of the workflow is shown. Initially a workflow is created and each step of the workflow is in the unassigned state 302, as shown in FIG. 2A. An administrator or workflow owner can assign the steps of the workflow to one or more users or roles that correspond to a group of users. Once one or more owners are assigned to a step, the state of the step is changed to assigned 304. After a step has been assigned to one or more owners, the owners may return the step and the state of the step will be updated to unassigned 302 if all owners are removed from the step. In exemplary embodiments, the addition of owners can only be performed by the current step owner or the owner of the workflow. In exemplary embodiments, once all of the steps have been assigned the steps that have no prerequisites will be selected and a notification is sent to the owner of those steps that indicates that the steps are ready to be performed.

In exemplary embodiments, once a step has been assigned to an owner it must be accepted by an owner. After the owner accepts the step, the state of the step is changed from assigned 304 to accepted 306. Next, once the step is ready for execution by the step owner the workflow updates the state of the step from accepted 306 to ready 308. For example, an owner may accept a step that depends upon the completion of a previous step that has not yet been completed. Once that previous step is completed, the workflow will automatically update the state of the dependent step from accepted 306 to ready 308. In exemplary embodiments, the workflow may be configured to alert the owner of a step when the state of that step is changed from accepted 306 to ready 308, thereby signaling that the step is ready for completion by the owner.

In exemplary embodiments, the execution of the step may be manual, semi-automated, or automated. In one embodiment, a manual step may include the user reading some instructions, performing the actions contained in the instructions and manually marking the step completed. In one embodiment, a semi-automated step may include the user filling in some data and pressing a button to run the step. In one embodiment, an automated step allows the workflow engine to perform the step if the prerequisite steps and data are present and does not require input from a user.

Once the user begins execution of a step, the state of the step is changed from ready 308 to in progress 310. In exemplary embodiments, the step remains in the in progress 310 state until that step is finished, at which point the state of the step is changed to complete 316. Once a step completes, the workflow engine looks at whether this step now places other steps in the accepted 306 state into the ready 308 state which causes additional notifications. Eventually all the steps of the workflow reach one of the terminal states 312 and the workflow is marked complete.

In exemplary embodiments, the state of a workflow step may include various terminal states 312 including, but not limited to, a complete (override) 312 state, a complete 316 state, a skipped 318 state and a not applicable 320 state. Once the state of a step is in one of the terminal states 312, the workflow may continue with the execution of subsequent or dependent steps. In exemplary embodiments, an override complete 322 action is always available, after a step has reached the accepted 306 state. When an owner executes the override complete 322 the owner may be warned that they are not performing the step as defined by the workflow description, and the state of the step is changed to complete (override) 314 rather than complete 316. In addition, an owner may execute a skip action once the step has reached the ready 308 state. Once a skip action is taken by an owner, the state of the step is updated to skipped 318 rather than complete 316. In exemplary embodiments, the not applicable 320 state can be automatically transitioned to from any other state in the workflow.

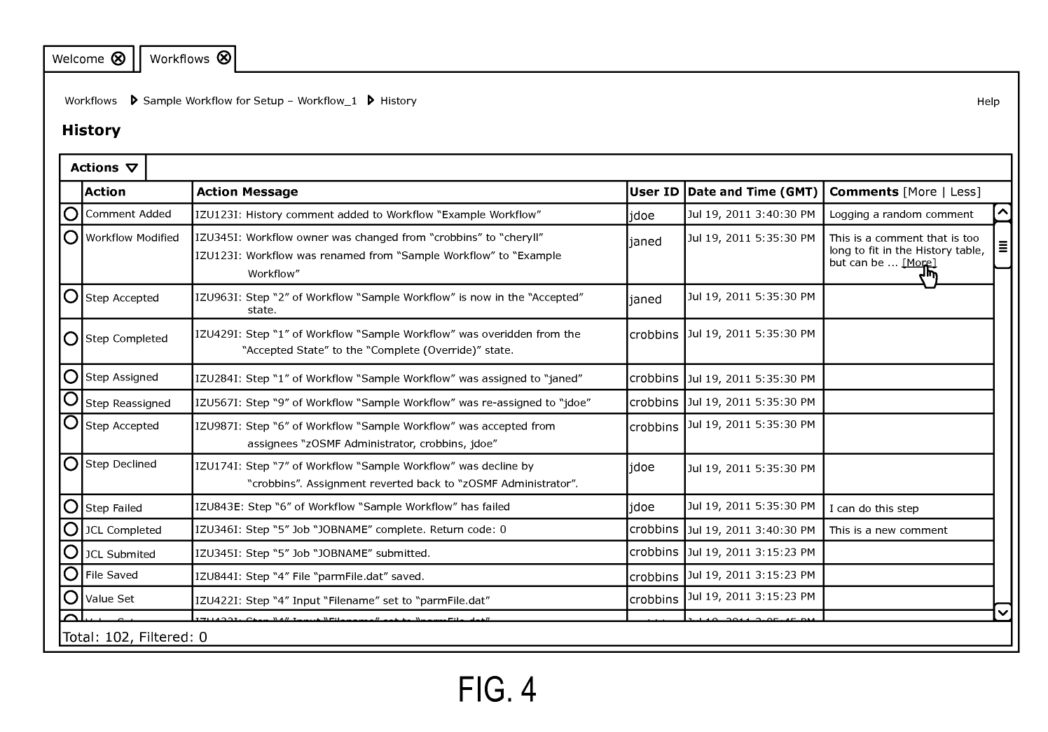

In exemplary embodiments, during execution of the workflow all state changes are logged and detailed information about the step processing is retained in a history file. FIG. 4 is an illustration of an example of a history file. The workflow can also retain notes about the processing for future reference, such as reasons provided by a user for skipping, or overriding a step. In exemplary embodiments, once a workflow has been completed it can be cloned for use later. Workflows can be used for the configuration of both local and remote systems.

In one embodiment, a customer may receive an operating system and corresponding new template; the customer may then tailor the template for their specific use. For example, the customer may add a step to communicate with their change management system. After the template has been tailored, the customer may execute the workflow and process the steps. When the execution of the workflow is compete, the customer may save the workflow to configure the product on another similar, or identical system.

In exemplary embodiments, the workflow may be used by higher level products, such as middleware, as part of their configuration. In exemplary embodiments, the workflows can also be used to perform configuration actions on both local and remote systems via cloning, and coordinating configuration action across clusters of systems. In addition, while the initial creation of the workflow is often a manual process the generation of subsequent workflows may at least partially automated and include versioning support. The definition of a workflow is independent of the workflow user interface and may uses standard technologies (xml, REST) that are part of the operating system.

In exemplary embodiments, the workflow engine is configured to ensure that the user or users are valid and authorized users on the system. Once a user is assigned a step from the workflow, the users will be notified of the assigned step. In one embodiment, when a user logs into the system the user will be presented with the tasks/steps assigned to them and what tasks/steps are ready for them to complete. In exemplary embodiments, the users may also be notified of assigned steps by email or other means prevalent in the industry.

In exemplary embodiments, the workflow engine may be running on one system operating a first instance of an operating system and be used to configure a second system operating a second instance of the operating system. For example, the workflow engine may be provided with a name or network location of a system to be configured by the workflow. In one embodiment, a driving system is a system where the workflow engine is running and one or more driven systems where the workflow is performing the actions identified in the steps. In exemplar embodiments, the driving and driven system may be the same system or separate systems.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” or other high level programming language or other similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the exemplary embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for executing a workflow comprising a plurality of steps to configure an operating system in which the workflow is embedded, comprising
assigning, with a workflow engine operated by a processing device, an owner to each of the plurality of steps;
receiving a notification of acceptance from the owner assigned to each of the plurality of steps;
monitoring a state of each of the plurality of steps;
notifying the owner of each of the plurality of steps when a step owned by the owner is ready for execution; and
indicating that the workflow is complete when all of the plurality of steps have reached a terminal state.

2. The method of claim 1, wherein the owner of each of the plurality of steps is assigned based on a role by the owner.

3. The method of claim 2, wherein the role is selected from a group comprising a system administrator, a security administrator, a storage administrator, a networking administrator, and a custom role created by the owner.

4. The method of claim 1, where the state of each of the plurality of steps is selected from a group comprising an unassigned state, an assigned state, an accepted state, a ready state, an in progress state, a complete state and a skipped state.

5. The method of claim 1, wherein the owner of one of the plurality of steps is notified that the step is ready for execution based on the state of the step being a ready state.

6. The method of claim 1, wherein the terminal state includes a complete state, a skipped state, a complete override state and a not applicable state.

7. The method of claim 1, further comprising changing the state of one of the plurality of steps to an in progress state once the owner of the state has began execution of the state.

8. A computer system for executing a workflow comprising a plurality of steps to configure an operating system, the computer system comprising:
a processor;
a workflow engine configured to operate on the processor, the workflow engine being configured to:
assign an owner to each of the plurality of steps;
receive a notification of acceptance from the owner assigned to each of the plurality of steps;
monitor a state of each of the plurality of steps;
notify the owner of each of the plurality of steps when a step owned by the owner is ready for execution; and
indicate that the workflow is complete when all of the plurality of steps have reached a terminal state.

9. The computer system of claim 8, wherein the owner of each of the plurality of steps is assigned based on a role by the owner.

10. The computer system of claim 9, wherein the role is selected from a group comprising a system administrator, a security administrator, a storage administrator, a networking administrator, and a custom role created by the owner.

11. The computer system of claim 8, where the state of each of the plurality of steps is selected from a group comprising an unassigned state, an assigned state, an accepted state, a ready state, an in progress state, a complete state and a skipped state.

12. The computer system of claim 8, wherein the owner of one of the plurality of steps is notified that the step is ready for execution based on the state of the step being a ready state.

13. The computer system of claim 8, wherein the terminal state includes a complete state, a skipped state, a complete override state and a not applicable state.

14. The computer system of claim 8, further comprising changing the state of one of the plurality of steps to an in progress state once the owner of the state has began execution of the state.

15. The computer system of claim 8, wherein the workflow engine is configured to executing the workflow to configure a second instance of the operating system on a second computer system.

16. A computer program product for executing a workflow comprising a plurality of steps to configure an operating system in which the workflow is embedded, the computer program product comprising:
a computer readable storage medium having computer readable program code embodied therewith, the computer readable program code being configured for:
assigning an owner to each of the plurality of steps;
receiving a notification of acceptance from the owner assigned to each of the plurality of steps;
monitoring a state of each of the plurality of steps;
notifying the owner of each of the plurality of steps when a step owned by the owner is ready for execution; and
indicating that the workflow is complete when all of the plurality of steps have reached a terminal state.

17. The computer program product of claim 16, wherein the owner of each of the plurality of steps is assigned based on a role by the owner.

18. The computer program product of claim 17, wherein the role is selected from a group comprising a system administrator, a security administrator, a storage administrator, a networking administrator, or a custom role created by the owner.

19. The computer program product of claim 16, where the state of each of the plurality of steps is selected from a group comprising an unassigned state, an assigned state, an accepted state, a ready state, an in progress state, a complete state and a skipped state.

20. The computer program product of claim 16, wherein the owner of one of the plurality of steps is notified that the step is ready for execution based on the state of the step being a ready state.

21. The computer program product of claim 16, further comprising changing the state of one of the plurality of steps to an in progress state once the owner of the state has began execution of the state.
